(19) United States
(12) Patent Application Publication
(10) Pub. No.: US 2023/0107079 A1
(43) Pub. Date: Apr. 6, 2023

(54) STUD PUNCH

(71) Applicant: MILWAUKEE ELECTRIC TOOL CORPORATION, Brookfield, WI (US)

(72) Inventors: Mackenzie NICK, Fond du Lac, WI (US); Beth E. CHOLST, Wauwatosa, WI (US); Troy C. THORSON, Cedarburg, WI (US)

(21) Appl. No.: 17/045,595

(22) PCT Filed: Jul. 17, 2020
(86) PCT No.: PCT/US2020/042457

§ 371 Date: Oct. 6, 2020

Related U.S. Application Data
(60) Provisional application No. 62/875,353, filed on Jul. 17, 2019.

(51) Int. Cl. B21D 28/24; B21D 28/00

(52) U.S. Cl. CPC B21D 28/243; B21D 28/002

(57) ABSTRACT

A stud punch includes a housing, a motor positioned within the housing, and a planetary gear train that receives torque from the motor. The stud punch also includes a punch movable between a retracted position and an extended position, and a scotch-yoke mechanism coupled between the planetary gear train and the punch. The scotch-yoke mechanism is configured to convert torque received from the planetary gear train to a reciprocating linear force, causing the punch to move between the retracted position and the extended position.

### CROSS-REFERENCE TO RELATED APPLICATIONS

This application claims priority to U.S. Provisional Patent Application No. 62/875,353, filed Jul. 17, 2019, the entire contents of which are hereby incorporated by reference.

### FIELD OF THE INVENTION

The present invention relates to power tools, and more particularly to stud punches.

### BACKGROUND OF THE INVENTION

Manual stud punches are used by electricians and plumbers to punch holes in steel studs, allowing plumbing, wires, and/or other materials to be run through the studs. Such manual tools are bulky, and can be difficult to manipulate in confined areas where studs may be located. These tools also require a large amount of exertion from the user to operate.

### SUMMARY OF THE INVENTION

The present invention provides, in one aspect, a stud punch including a housing, a motor positioned within the housing, a planetary gear train that receives torque from the motor, a punch movable between a retracted position and an extended position, and a scotch-yoke mechanism coupled between the planetary gear train and the punch. The scotch-yoke mechanism is configured to convert torque received from the planetary gear train to a reciprocating linear force, causing the punch to move between the retracted position and the extended position.

The present invention provides, in another aspect, a stud punch including a housing, and a stud punch head coupled to the housing. The stud punch head includes a head housing, a punch supported by the head housing, an arm extending from the head housing and defining an aperture therein, and a die that is removably received within the aperture.

The present invention provides, in another aspect, a stud punch including a housing and a stud punch head coupled to the housing. The stud punch head includes a head housing that defines an opening, and a punch supported by the head housing and movable between a retracted position located within the opening and an extended position extending outward from the opening. The stud punch head also includes a guard movably supported by the head housing and configured to shield the opening as the punch moves from the retracted position to the extended position.

Other features and aspects of the invention will become apparent by consideration of the following detailed description and accompanying drawings.

### BRIEF DESCRIPTION OF THE DRAWINGS

FIG. 1 is a perspective view of a powered stud punch in accordance with an embodiment of the invention.

FIG. 2 is another perspective view of the stud punch of FIG. 1.

FIG. 3 is a cross-sectional view of the stud punch of FIG. 1, taken along line 3-3 of FIG. 2.

FIG. 4 is an enlarged cross-sectional view of a portion of the stud punch of FIG. 1, taken along line 3-3 of FIG. 2.

FIG. 5 is another enlarged cross-sectional view of a portion of the stud punch of FIG. 1, taken along line 3-3 of FIG. 2.

FIG. 6 is a cross-sectional view of the stud punch of FIG. 1, taken along line 6-6 of FIG. 2.

FIG. 7 is a partially exploded side view of a portion of the stud punch of FIG. 1.

FIG. 8 is a side view of a portion of the stud punch of FIG. 1.

FIG. 9 is another side view of a portion of the stud punch of FIG. 1.

FIG. 10 is a top view of the stud punch of FIG. 1.

FIG. 11 is another side view of the stud punch of FIG. 1.

FIGS. 12A-12D are cross-sectional views of the stud punch of FIG. 1, taken along line 6-6 of FIG. 2.

FIG. 13 is a graph illustrating a stud punch force generated by the stud punch of FIG. 1 during a punch cycle at various wheel angles.

FIG. 14 is a graph illustrating the results of a punch test performed on a nonstructural stud using the stud punch of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

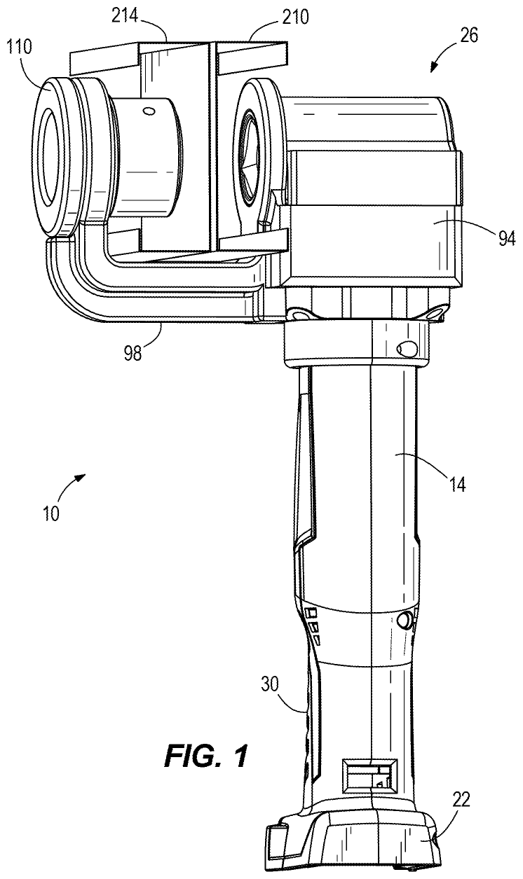

With reference to FIGS. 1-3, a powered stud punch 10 is operable to create (e.g., punch) a hole in a metal stud 210 (or two adjacent studs 210, 214) to facilitate running wires and/or plumbing, as well as other materials, through the stud 210. In the illustrated embodiment, the stud punch 10 is configured to receive nonstructural metal studs (e.g., sixteen to twenty-five gauge steel studs), with other gauges of metal studs also being contemplated.

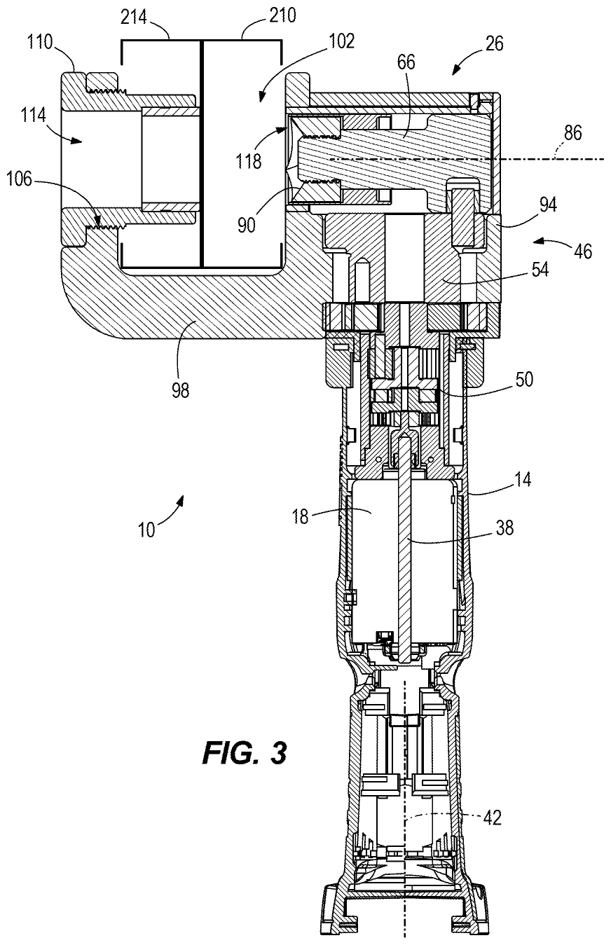

The stud punch 10 includes a housing 14, a motor 18 (FIG. 3) positioned within the housing 14, a battery mount portion 22 for removably coupling a battery pack (not shown) located at one end of the housing 14, and a stud punch head 26 coupled to the other end of the housing 14. The battery pack may include any of a number of different nominal voltages (e.g., 12V, 18V, etc.), and may be configured having any of a number of different chemistries (e.g., lithium-ion, nickel-cadmium, etc.). In alternative embodiments (not shown), the motor 18 may be powered by a remote power source (e.g., a household electrical outlet) through a power cord.

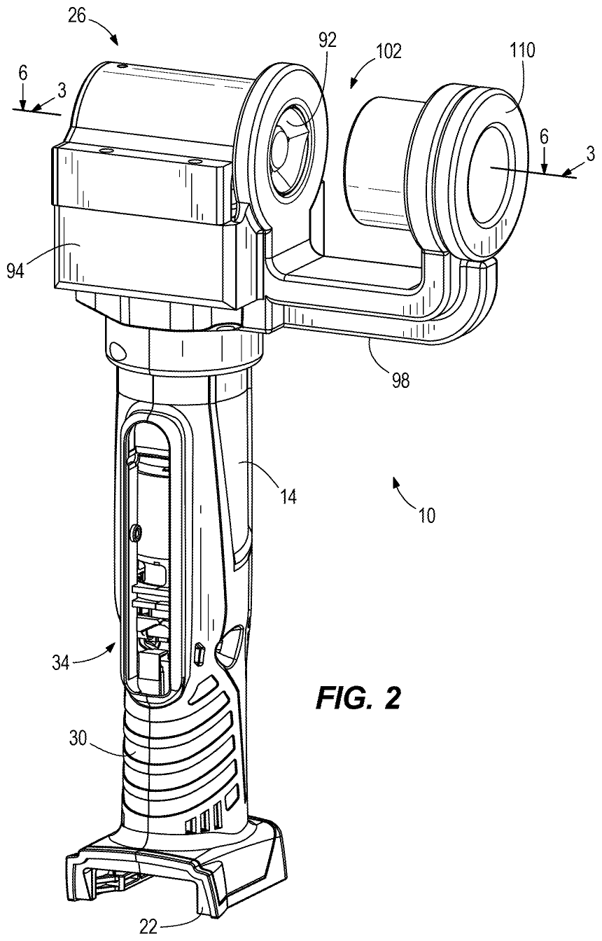

The housing 14 also includes a hand grip 30 configured to be grasped by a user (FIG. 2). A switch assembly 34 is supported by the housing 14 proximate the hand grip 30 that may be actuated by a user to electrically connect the battery to the motor 18, thereby supplying power to the motor 18.

With reference to FIG. 3, the motor 18 is positioned within the housing 14. The motor 18 is electrically coupled to the battery pack and includes a motor shaft 38 rotatable about a motor axis 42. The motor shaft 38 provides torque to a punch mechanism 46 of the stud punch head 26. In the illustrated embodiment, the motor 18 is an electric motor configured to supply motive force to the punch mechanism 46. In other embodiments, the motor 18 may be a hydraulic motor, a pneumatic motor, or the like.

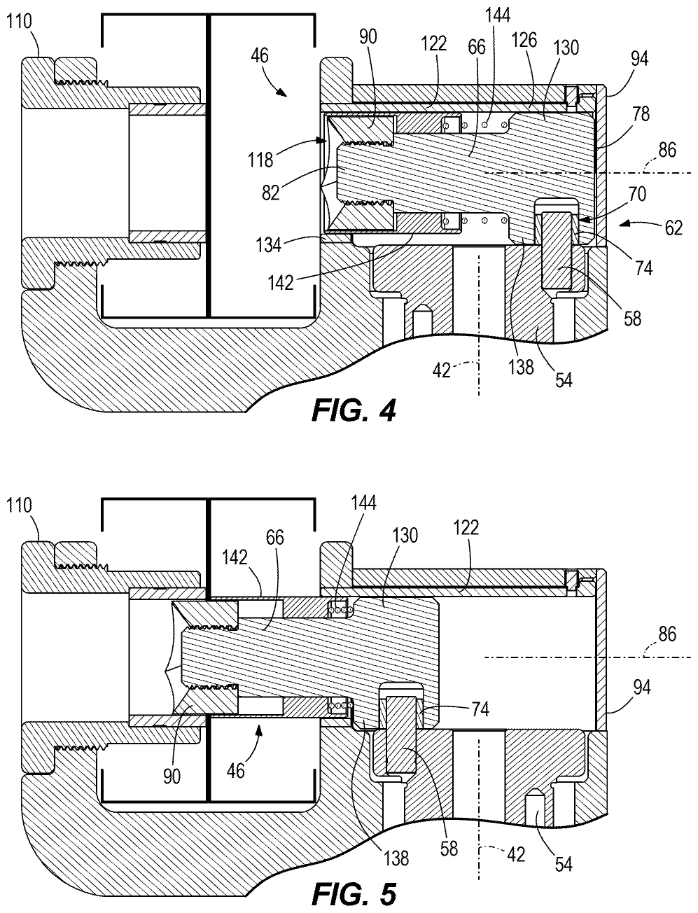

The stud punch 10 also includes a planetary gear train 50 (e.g., a single or multi-stage planetary gear train) positioned between the motor 18 and the punch mechanism 46. The punch mechanism 46 includes a final-stage carrier or wheel 54, and the wheel 54 supports a drive pin 58 (FIG. 4) for eccentric rotation about the motor axis 42. The planetary gear train 50 is positioned between the motor shaft 38 and the wheel 54 to reduce the rotational speed of the motor shaft 38 to a suitable value for the wheel 54. For example, in some embodiments, the planetary gear train 50 may be configured to provide a 246.15:1 reduction between the motor shaft 38 and the wheel 54. In other embodiments, the gear reduction may be greater or lesser. In other embodiments, a different type of gear train may be used. In other embodiments, a gear train may not be needed if the motor can supply the necessary torque and speed without a gear reduction.

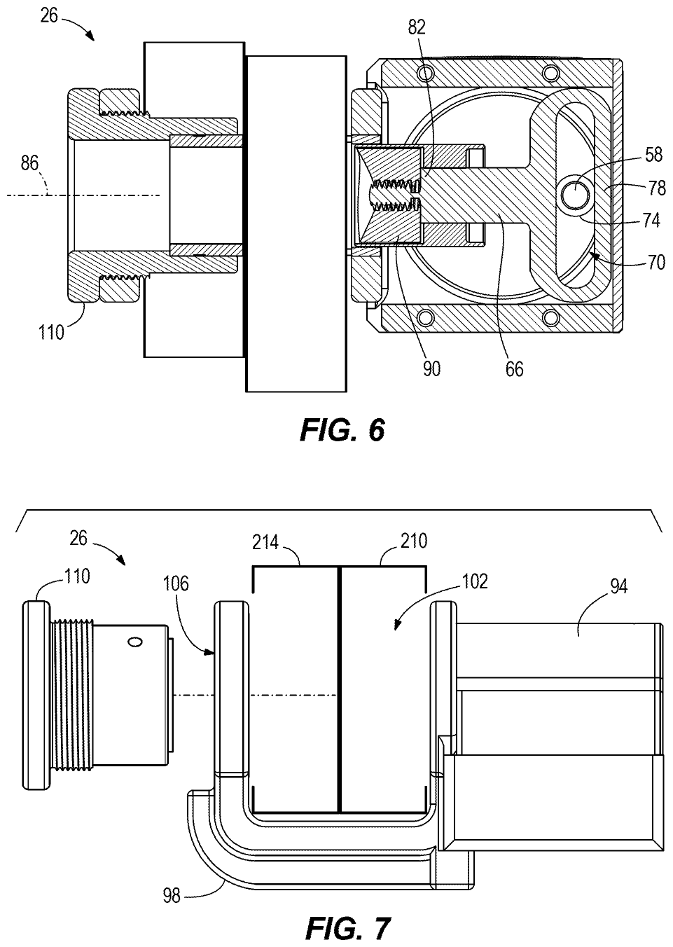

With reference to FIGS. 3-6, the punch mechanism 46 includes a scotch-yoke mechanism 62 that includes the drive pin 58, a yoke 66 that defines an elongated recess 70, and a roller 74. The yoke 66 includes a first end portion 78 and a second end portion 82. The yoke 66 also defines a longitudinal axis 86 that extends generally centrally through the yoke 66 along the length of the yoke 66. The elongated recess 70 extends through the first end portion 78 of the yoke 66, and the roller 74 is received within the recess 70. The roller 74 is coupled to the drive pin 58 for movement with the drive pin 58 about the motor axis 42. A punch 90 is coupled to the second end portion 82 of the yoke 66, and the scotch-yoke mechanism 62 reciprocates the punch 90 along the longitudinal axis 86 upon rotation of the motor shaft 38 about the motor axis 42. The illustrated punch 90 is generally cylindrical and includes a contoured surface 92 (FIG. 2) to cut or punch a circular hole in a stud. In other embodiments, the punch 90 may be pyramidal, irregular, or have other shapes to punch a differently shaped hole in the stud. In some embodiments, multiple punches 90 may be supported by the yoke 66 to simultaneously punch multiple holes in the stud.

With reference to FIG. 3, the stud punch head 26 includes a head housing 94 in which the punch mechanism 46 is supported and a bracket or arm 98 extending away from the head housing 94. A slot 102 for receiving the stud 210 (or studs 210, 214) is defined between the arm 98 and the head housing 94. The arm 98 defines an aperture 106 at a distal end thereof, with the aperture 106 generally centered about the longitudinal axis 86. In the illustrated embodiment, the aperture 106 removably receives a threaded die 110 that defines a central bore 114. In other embodiments (not shown), the die 110 may be integrally formed as a single piece with the arm 98. The die 110 is positioned opposite the punch 90 with respect to the slot 102, such that the die 110 receives the punch 90 as the yoke 66 moves from a retracted position (FIG. 4) to an extended position (FIG. 5). It should be readily apparent to those skilled in the art that the central bore 114 of the die 110 generally corresponds to the shape and size of the punch 90. In embodiments where the yoke 66 supports multiple punches 90, the arm 98 may support multiple dies 110 corresponding to the multiple punches.

With reference to FIG. 4, the head housing 94 defines an opening 118 generally centered about the longitudinal axis 86 and located opposite the aperture 106 (FIG. 3) with respect to the slot 102. The punch 90 resides within the opening 118 in the retracted position, and exits the head housing 94 via the opening 118 as the yoke 66 moves from the retracted position to the extended position. The punch head 26 also includes a guide 122 supported by the head housing 94. The guide 122 includes a channel portion 126 that supports an upper portion 130 of the yoke 66, and a tube portion 134 that resides within the opening 118. A lower portion 138 of the yoke 66 is supported by the wheel 54.

With reference to FIGS. 4 and 5, the punch mechanism 46 further includes a guard 142 slideably supported within the tube portion 134 of the guide 122, and slideably captured about the yoke 66. The guard 142 is biased toward the punch 90 by a spring 144, and inhibits foreign particles (e.g., dust, dirt, chips, etc.) from entering into the head housing 94 and disrupting the movement of the punch mechanism 46. The guard 142 also centers the second end portion 82 of the yoke 66 to circumferentially align the yoke 66 with respect to the opening 118. When the yoke 66 is at the retracted position prior to initiation of a punching operation (FIG. 4), the guard 142 extends beyond the punch 90 in a direction along the longitudinal axis 86 from the opening 118 toward the die 110. The guard 142 travels with the yoke 66 during a punching operation to surround the punch 90 up until the punch 90 engages and punches through the stud 210, as will be discussed below.

A punch cycle of the stud punch 10 is defined as a movement of the yoke 66 through a punch stroke (from the retracted position shown in FIG. 4 to the extended position shown in FIG. 5), and back through a return stroke (from the extended position to the retracted position). In the illustrated embodiment, the stud punch 10 completes one punch cycle in less than one second. The punch cycle is initiated when the user actuates the switch assembly 34. The motor 18 is activated to rotate the motor shaft 38, and the motor shaft 38 rotates the gears within the planetary gear train 50 to rotate the wheel 54. The wheel 54 rotates the drive pin 58, causing the roller 74 to move within the elongated recess 70. As the roller 74 moves within the recess 70, the yoke 66 completes a punch cycle by moving between the retracted position (FIG. 4), the extended position (FIG. 5), and back to the retracted position. The wheel 54 rotates through a single revolution (i.e., 360 degrees) to complete one punch cycle.

The stud punch head 26 is positioned about the stud 210 (or studs 210, 214) such that the stud 210 is within the slot 102 and opens toward either the die 110 or the punch 90. As the yoke 66 moves through a punch stroke from the retracted position toward the extended position, the punch 90 contacts one side of the stud 210 while the die 110 contacts an opposite side of the stud 210. As the yoke 66 continues to the extended position, the punch 90 cuts through the stud 210 and slides into the bore 114 within the die 110, thereby creating a hole in the stud 210.

The guard 142 is biased toward contact with the punch 90 by the spring 144, such that during the punch stroke of the yoke 66, the guard 142 travels with the punch 90 up until the punch 90 engages and punches through the stud 210. Once the punch 90 makes contact with the stud 210, the guard 142 likewise makes contact with the stud 210 and is prevented by the stud 210 from further travel toward the die 110. Contact between the guard 142 and the stud 210 causes the spring 144 to compress as the punch 90 continues to travel through the stud 210 and into the die 110 to the extended position. During the return stroke of the yoke 66, the guard 142 remains in contact with the stud 210 until the punch 90 passes back through the newly-formed hole, at which point the guard 142 reestablishes contact with the punch 90 and travels back into the head housing 94 through the opening 118. In this way, the guard 142 prevents foreign particles and debris from entering into the head housing 94 via the opening 118.

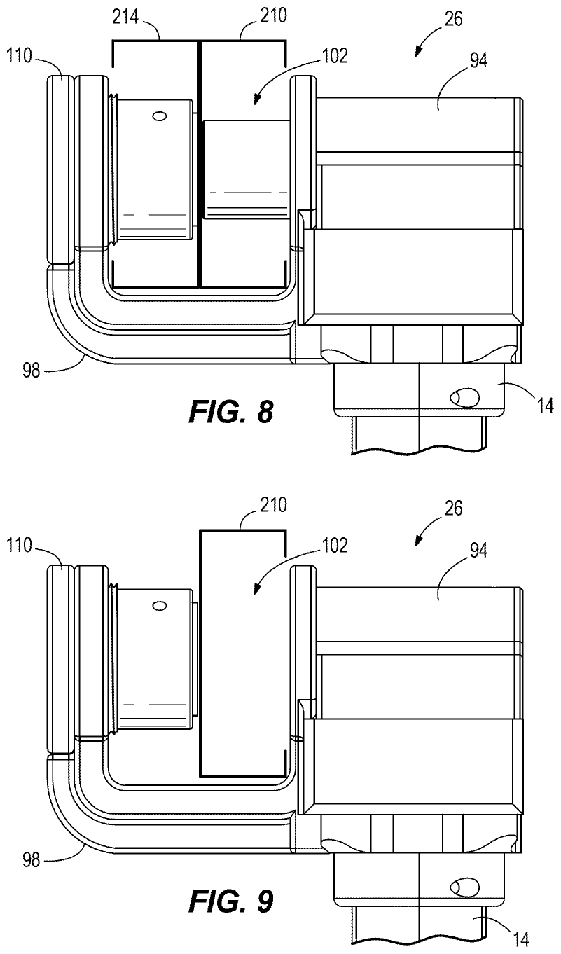

With reference to FIGS. 7-9, the die 110 is removable so that two adjacent studs 210, 214 may simultaneously be positioned within the slot 102. Specifically, to simultaneously perform a punching operation through two studs 210, 214, the die 110 is first removed from the aperture 106 (FIG. 7). Then the stud punch head 26 can be positioned about both studs 210, 214 such that both studs 210, 214 are within the slot 102. The die 110 is then re-inserted into the aperture 106 (FIG. 8), at which point a punching operation may be performed. If only one stud 210 is being punched (FIG. 9), the die 110 does not need to be removed because the stud punch head 26 can be positioned about the single stud 210 while the die 110 remains inserted in the aperture 106.

In some embodiments, the construction of the stud punch 10 including the planetary gear train 50 and scotch-yoke mechanism 62 permits the use of a prefabricated or canned motor 18, and provides for an overall tool weight of between 6.5 and 7.5 pounds.

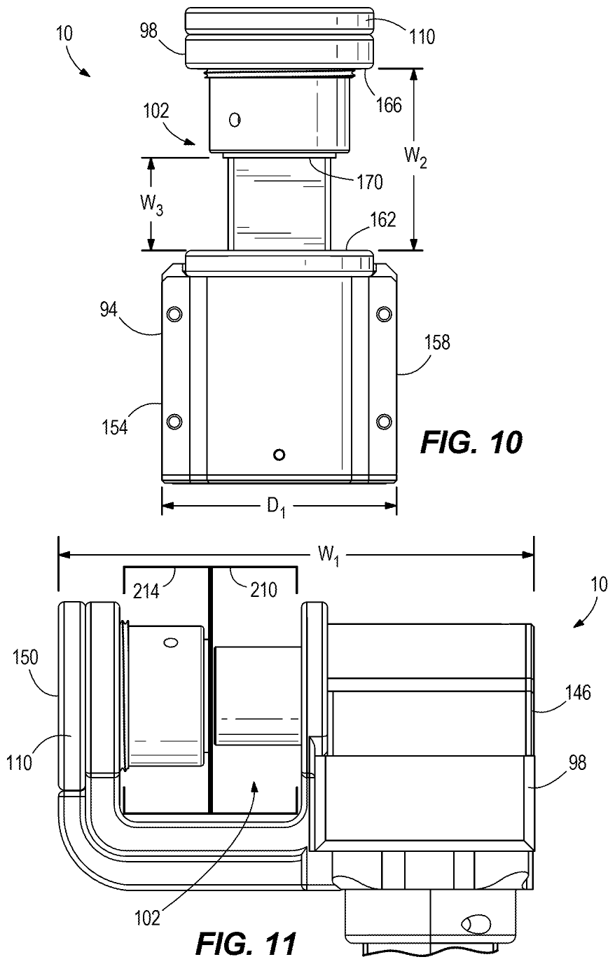

With reference to FIGS. 10 and 11, the construction of the stud punch 10 also contributes to an overall compact size and form factor as compared to other known stud punches. In the illustrated embodiment, the stud punch 10 has an overall extent or tool width W1, measured between a rearward face 146 of the head housing 94 and a forward face 150 of the die 110, of about seven inches. Likewise, the stud punch 10 has an overall tool depth D1, measured between first and second side surfaces 154, 158 of the head housing 94, of approximately 3.44 inches.

A first slot surface 162 is located on the head housing 94 adjacent the opening 118 and facing the slot 102, and a second slot surface 166 is located on the arm 98 adjacent the aperture 106 and facing the slot 102 (FIG. 10). When the die 110 is installed in the aperture 106, a contact surface 170 of the die 110 is located at a furthest extent of the die 110 facing the slot 102. A maximum slot width W2 of the slot 102 is defined between the first slot surface 162 and the second slot surface 166. In the illustrated embodiment, the maximum slot width W2 is about 2.66 inches. When the die 110 is installed in the aperture 106, a minimum slot width W3 of the slot 102 is defined between the first slot surface 162 and the contact surface 170. In the illustrated embodiment, the minimum slot width W3 is approximately 1.33 inches, or approximately half of the maximum slot width W2.

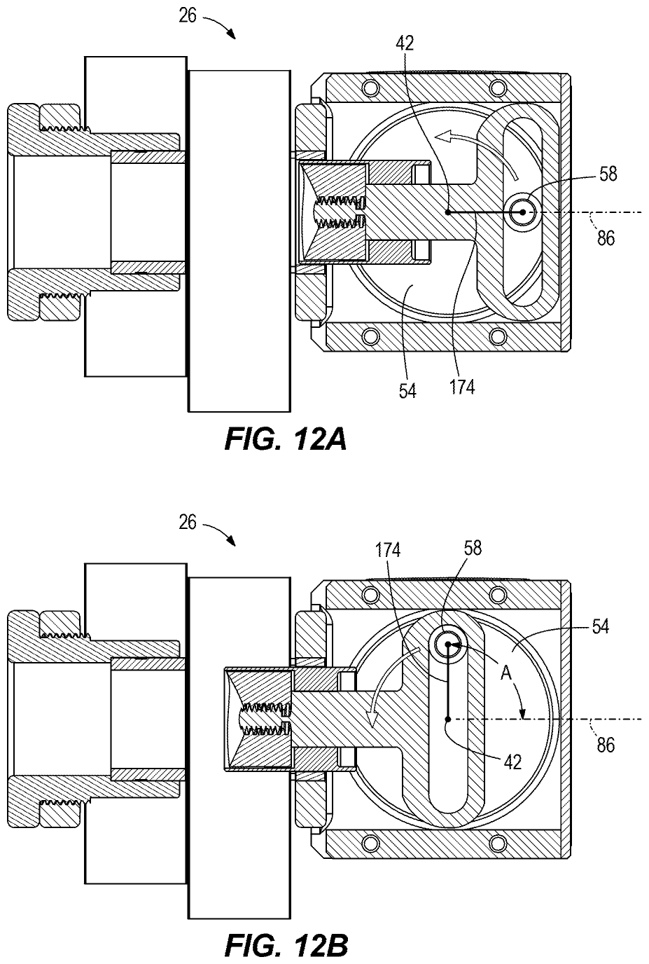

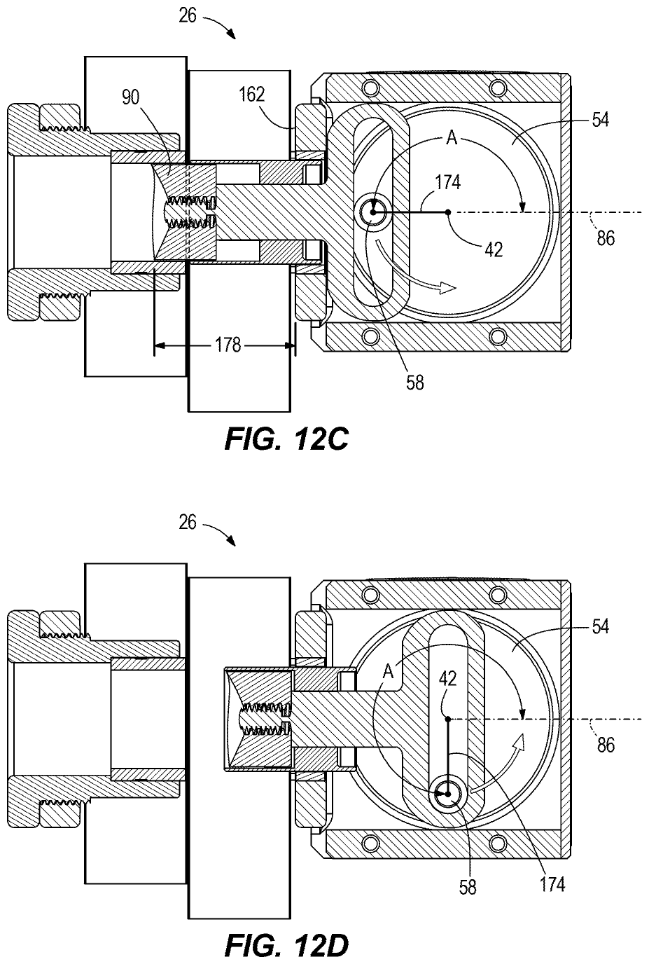

FIGS. 12A-12D illustrate four different rotational positions of the wheel 54 that correspond to four different stages of the punch cycle. Specifically, FIG. 12A shows the wheel 54 at a first rotational position corresponding to the retracted position of the yoke 66, or the beginning of the punch stroke and the end of the return stroke. FIG. 12B shows the wheel 54 at a second rotational position corresponding to an intermediate stage of the punch stroke. FIG. 12C shows the wheel 54 at a third rotational position corresponding to the extended position of the yoke 66, or the end of the punch stroke and the beginning of the return stroke. FIG. 12D shows the wheel 54 at a fourth rotational position corresponding to an intermediate stage of the return stroke.

A wheel angle A of the wheel 54 is defined between the longitudinal axis 86, and a pin line 174 extending between the motor axis 42 and the drive pin 58. The wheel angle A corresponds to an angular distance travelled by the wheel from the first rotational position depicted in FIG. 12A. The first rotational position of the wheel 54 corresponds to a wheel angle A of about 0 degrees, the second rotational position corresponds to a wheel angle A of about 90 degrees, the third rotational position corresponds to a wheel angle A of about 180 degrees, and the fourth rotational position corresponds to a wheel angle A of about 270 degrees. As the punch 90 proceeds through a punch stroke from the retracted position to the extended position, the punch 90 makes contact with and engages the stud 210 at an engagement position intermediate the retracted and extended position. In the illustrated embodiment, the engagement position of the punch 90 corresponds to a wheel angle A of about 115 degrees.

FIG. 12C further illustrates a stroke length 178 of the stud punch 10. The stroke length is defined between the first slot surface 162 of the head housing 94 and a furthest extent of the punch 90 at the extended position. In some embodiments, the stud punch 10 includes a stroke length 178 between about 1.5 and 2.0 inches. In the illustrated embodiment, the stroke length 178 is about 1.85 inches.

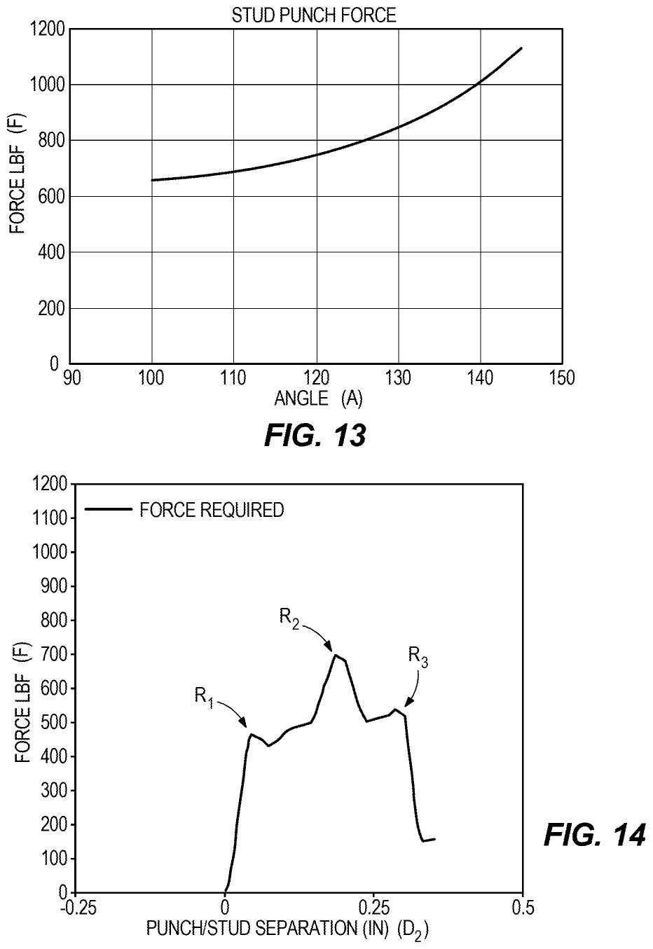

FIG. 13 illustrates a stud punch force F generated by the stud punch 10 during a punch cycle at various wheel angles A. In the illustrated embodiment, the stud punch 10 generates a stud punch force F in excess of 600 pounds throughout the punch stroke.

FIG. 14 illustrates the results of a punch test performed on a nonstructural stud with the stud punch 10. Nonstructural studs commonly measure 25 gauge. The results are depicted as a graph of punch force F plotted against a punch separation distance D2 travelled by the punch 90 along the longitudinal axis 86. The punch separation distance D2 indicates the distance traveled from initial contact of the punch 90 with the surface of the stud, to the completed punch. That is, a distance of zero corresponds to initial contact between the punch 90 and the surface of the stud, and the punch separation distance D2 is measured up until a punch is completed and the resulting hole is formed. It is noteworthy that the punch force F required to punch is dependent on the shape of the punch face of the punch 90. According to FIG. 14, an initial rise R1 in punch force F is to drive points of punch 90 through stud material. A second and largest rise R2 is forcing the punch 90 through the stud material, and the lowered rise R3 in punch force F is after initial shear, when stud material is actually separating.

Various features of the disclosure are set forth in the following claims.

What is claimed is:

1. A stud punch comprising:
a housing;
a motor positioned within the housing;
a planetary gear train that receives torque from the motor;
a punch movable between a retracted position and an extended position; and
a scotch-yoke mechanism coupled between the planetary gear train and the punch,
wherein the scotch-yoke mechanism is configured to convert torque received from the planetary gear train to a reciprocating linear force, causing the punch to move between the retracted position and the extended position.

2. The stud punch of claim 1, wherein the motor defines a motor axis, the planetary gear train comprises a wheel that receives torque from the motor, and the scotch-yoke mechanism comprises a drive pin supported by the wheel for eccentric rotation about the motor axis.

3. The stud punch of claim 2, wherein the scotch-yoke mechanism further comprises a yoke defining an elongated recess that receives the drive pin, and wherein the punch is removably coupled to the yoke.

4. The stud punch of claim 3, wherein the punch moves from the retracted position to the extended position and back to the retracted position to complete a punch cycle, and wherein the wheel completes one revolution about the motor axis to effect one punch cycle.

5. The stud punch of claim 1, further comprising a head housing defining an opening, and an arm that extends from the head housing and that defines an aperture therein, the aperture being opposed to the opening.

6. The stud punch of claim 5, wherein a slot is defined between the arm and the head housing, and the slot is configured to receive a metal stud.

7. The stud punch of claim 5, further comprising a die removably received within the aperture.

8. The stud punch of claim 7, wherein the die defines a central bore, and wherein the punch resides within the opening in the retracted position, and the punch is received into the central bore in the extended position.

9. The stud punch of claim 5, further comprising a guard movably supported by the head housing and configured to shield the opening as the punch moves from the retracted position to the extended position.

10. The stud punch of claim 9, wherein the guard surrounds the punch in the retracted position, and wherein the guard moves together with the punch as the punch moves from the retracted position toward the extended position.

11. The stud punch of claim 9, wherein the guard is movable relative to the punch and biased toward engagement with the punch.

12. A stud punch comprising:
a housing; and
a stud punch head coupled to the housing, the stud punch head including
a head housing,
a punch supported by the head housing,
an arm extending from the head housing and defining an aperture therein, and
a die that is removably received within the aperture.

13. The stud punch of claim 12, wherein the head housing defines an opening opposed to the aperture, and wherein the punch is movable between a retracted position residing within the opening and an extended position received into the die.

14. The stud punch of claim 13, further comprising a guard movably supported by the head housing and configured to shield the opening as the punch moves from the retracted position to the extended position.

15. The stud punch of claim 13, further comprising a motor and a scotch-yoke mechanism configured to convert torque received from the motor to a reciprocating linear force, causing the punch to move between the retracted position and the extended position.

16. The stud punch of claim 12, further comprising a motor and a planetary gear train that receives torque from the motor.

17. A stud punch configured to punch through a metal stud to form a hole, the stud punch comprising:
a housing; and
a stud punch head coupled to the housing, the stud punch head including
a head housing that defines an opening,
a punch supported by the head housing and movable between a retracted position located within the opening and an extended position extending outward from the opening, and
a guard movably supported by the head housing and configured to shield the opening as the punch moves from the retracted position to the extended position.

18. The stud punch of claim 17, further comprising a motor and a scotch-yoke mechanism configured to convert torque received from the motor to a reciprocating linear force, causing the punch to move between the retracted position and the extended position.

19. The stud punch of claim 17, further comprising an arm extending from the head housing and defining an aperture therein, the aperture being opposed to the opening, wherein a slot is defined between the arm and the head housing, and the slot is configured to receive the metal stud.

20. The stud punch of claim 19, further comprising a die that is removably received within the aperture, the die being removable to expand a width of the slot to receive two adjacent studs.
